(19) United States
(12) Patent Application Publication
(10) Pub. No.: US 2004/0080774 A1
(43) Pub. Date: Apr. 29, 2004

(54) Printing after consumable exhaustion

(76) Inventors: Kevin Owen, Meridian, ID (US); Jeetendra Kumar, Boise, ID (US); Travis Moats, Nampa, ID (US)

Correspondence Address: HEWLETT-PACKARD COMPANY, Intellectual Property Administration, P.O. Box 272400, Fort Collins, CO, 80527-2400, US

(21) Appl. No.: 10/282,426

(22) Filed: Oct. 29, 2002

(51) Int. Cl. G06F 3/12; G06F 13/00; G06F 15/00; G06F 11/30

(52) U.S. Cl. 358/1.14; 710/19; 399/24; 399/27; 358/1.15

(57) ABSTRACT

A printing device has a replaceable component. Printing by the printing device utilizes the replaceable component. Printing with the printing device is stopped when an end-of-life condition is detected for the replaceable component. The end-of-life condition signifies potential quality degradation if printing with the printing device is resumed. The end-of-life condition is reflected in a diagnostic that is output. In response to an input of a demand for resumption of the printing, the printing can be resumed.

### FIELD OF THE INVENTION

The present invention relates to printing that uses a consumable. More particularly, the invention relates to printing after a consumable has been estimated to have been exhausted.

### BACKGROUND OF THE INVENTION

Most types of printing devices are equipped with replaceable components that have a life cycle during which the replaceable components are functional. Such replaceable components include toner in a toner cartridge, ink in an ink cartridge, a fuser, a drum, etc. At the end of the life cycle of a replaceable component, the component must be replaced for the printing device to continue to function properly. For example, toner or another replaceable component can be installed in a laser printer to provide a printing supply for the printing process. Replaceable components can be manufactured with memory which can be placed on the component itself or within a label affixed to the component. This memory is typically used to store printer-related data that the printer reads to determine various printing parameters. For example, the memory may store the model number of the component so that the printer may recognize the cartridge as valid or invalid for use with that printer.

As documents are printed, the replaceable component is gradually depleted. The printer communicates with the memory of the replaceable component to estimate when a state of exhaustion has been reached. Once the replaceable component has been estimated to have been exhausted, the printer will stop printing. The printer is also configured to resume printing when the replaceable component is replaced.

In making the estimation of the exhaustion of a replaceable component, a safety margin is generally included to account for variables such as temperature, humidity, sensor inaccuracy, etc. The safety margin effectively decreases the likelihood of printing any portion of the complete printout with poor print quality. As such, the replaceable component may be sufficient to print some, and perhaps the entire print job with good or near-good print quality. For instance, if a printer is printing a one hundred (100) page print job and the toner in the toner cartridge is sensed as reaching its safety margin for a state of out toner at the ninetieth (90th) page, the remaining ten (10) pages will not be printed. If the remaining ten (10) pages could be printed by the printer, they would likely still be readable, possibly with lighter printed characters due to the exhausted toner condition.

Once the printing device determines that the margin of safety for the replaceable component has been exceeded so as to establish an end-of-life condition, the printing stops. The cessation from printing can occur at any point in a print job that a user has requested and has been waiting for. If a user cannot locate or is otherwise unable to obtain or install the needed replaceable component, the user will not be able to obtain the desired complete printout. Frustration can arise for the user where only a draft copy of the complete print job is needed and the user is not particularly concerned with the resultant print quality. Consequently, there is a need for improved methods and printing devices that can provide the user with the desired complete printout after a replaceable component is estimated to have been exhausted.

### SUMMARY OF THE INVENTION

The above-stated needs and/or others are met, for example, by a printing device that has a replaceable component that is used to print. Printing is stopped in response to an end-of-life condition of the replaceable component that signifies a potential quality degradation of the printing if the printing is resumed. A diagnostic is output reflecting the end-of-life condition and the printing is resumed in response to an input of a demand for resumption of the printing.

### DESCRIPTION OF THE DRAWINGS

The present invention is illustrated by way of example and not limitation in the figures of the accompanying drawings. The same numbers are used throughout the figures to reference like components and/or features.

FIG. 1 illustrates a network environment in which multiple servers, one or more workstations, and printers are coupled to one another via an interconnected network.

FIG. 2 is a diagrammatic illustration of a laser printer.

FIG. 3 is a diagrammatic illustration of a laser printer toner cartridge in a laser printer.

FIG. 4 is a block diagram of a printing system.

FIG. 5 is a flow diagram of a dynamic messaging process utilizing memory in printer components.

FIG. 6 is a diagram of a messaging process for user communication.

FIG. 7 is a diagram of a messaging process for user communication.

### DETAILED DESCRIPTION

Methods and printing devices, according to various implementations, relate to a client device or document processing device such as personal computer (PC) that executes a document processing application, such as a word processor application, that creates and/or stores a document that is to be output at a printer. The document processing application typically has a printer driver application that can be used to create print data from a document that has been stored and/or created. In order to print out the document, the document processing application receives a request for a printing function to obtain a print out on a printer specified in the requested printing function. The printing function sends print data to the requested printer and the printing of a corresponding print job begins. If at any point during the printing of the print job it is estimated that there are insufficient printing supplies to print the remainder of the print job, the printer will stop printing and a diagnostic will be output that references the estimated insufficiency. A prompt can also be output that requests input to resume the printing operation despite the estimated insufficiency. The input in response to the prompt will resume the printing of the print job for the remainder, or a specified portion of, the print job. As such, the response to the prompt is honored and the one responsible for the input will have assumed the risk of the possibility of decreased quality in the resultant remainder of the print job.

In an alternative implementation, the printing device has a replaceable component. The replaceable component, which has a useable life, gets used up as the printing device prints. The printing at the printing device stops in response to an estimated end-of-life condition of the replaceable component. The end-of-life condition signifies a potential quality degradation of the printed result if the printing is resumed. A diagnostic is output that reflects the end-of-life condition. Printing will resume at the printing device in response an input of a demand for resumption of the printing. In addition to the diagnostic, a prompt can also be output that solicits resumption of the printing, in which case the input can be made in response to the prompt.

The printing device can include a memory for storing replaceable component usage data used in estimating the end-of-life condition of the replaceable component. The replaceable component usage data in the memory is updated during the printing. The memory can, but need not be, integral with the replaceable component. Examples of integral memory are a radio frequency identification (RFID) memory and a direct contact identification memory.

The potential quality degradation of the printing can vary depending, for example, upon the type of printing device to which a print job is directed and the type of replaceable component being used by the printing device. The quality of the print job, if resumed after stopping the printing, may not immediately decrease because a margin of safety can be built into the end-of-life condition against which the replaceable component is measured. The end-of-life condition can be an insufficiency of printing supplies in the replaceable component. By way of example, and not by way of limitation, this insufficiency can be the printing media available to be printed on during the printing, the printing substance (e.g. printing ink) available for application to the printing media during the printing, the toner available for application to the printing media during the printing, an exhaustible aspect of a laser printer drum, developer, or fuser that can be used while printing on a laser printer, an exhaustible aspect of a printing media transfer belt, staples that are available for stapling the printing media during the printing, or storage available for storing the printing media after it has been printed by the printing device.

In various implementations, the printing device and/or the replaceable component can have one or more sensors. Each sensor can sense an aspect of the replaceable component related to the exhaustion thereof. The printing is stopped in response to an end-of-life condition of the replaceable component that is derived by comparing the aspect sensed by a sensor to a corresponding predetermined quantity. This comparison of the sensed condition can be with any of the foregoing list of replaceable components to identify potential insufficiencies to complete the remainder of a print job.

The printing device has an input mechanism to receive a demand for resuming the printing operation. The input mechanism can be a button or a toggle switch on the printing device that can be depressed of otherwise activated by a user. The input mechanism can also be an input device in communication with a computing device that is in communication with the printing device.

An output mechanism can be associated with the printing device upon which the diagnostic can be displayed. The output mechanism can be a display screen on the printer or a display screen in communication with a computing device that is in communication with the printing device. The diagnostic can be printed on a hardcopy printout that is printed by the printing device.

The memory can be used to store replaceable component usage data during the printing operations after the replaceable component is installed in the printing device. The replaceable component usage data can be used to estimate when the replaceable component is at an end-of-life condition. The estimating can be made by comparing the replaceable component usage data in the memory to a corresponding predetermined quantity. The replaceable component usage data can be stored in the memory periodically during the printing operations and/or at predetermined intervals.

By way of example, and not by way of limitation, a laser printer can have a toner cartridge that is installable in and removable from the laser printer. The toner cartridge can have a memory that is configured to store replaceable component usage data received from a reader/writer located in the laser printer. The reader/writer monitors replaceable component usage data. The reader/writer can compare a predetermined quantity to the replaceable component usage data to estimate that the toner cartridge is exhausted or is likely to be near exhaustion. The memory, which can be an RFID memory or a direct contact identification memory, can also store an out-of-toner status received from the reader/writer after the reader/writer estimates, based on the monitoring, that the toner in the toner cartridge is near exhaustion. A sensor can also be used to monitor the available quantity of toner in the toner cartridge. The reader/writer can receive the available quantity of toner in the toner cartridge from the sensor which can in turn be used to estimate that the toner in the toner cartridge is near exhaustion. Alternatively, the replaceable component usage data can be a page count received from a page counter in the reader/writer that maintains a page count that is the number of pages printed using the toner cartridge. Once this page count is compared to a predetermined maximum page count, the toner cartridge can be estimated to be near exhaustion.

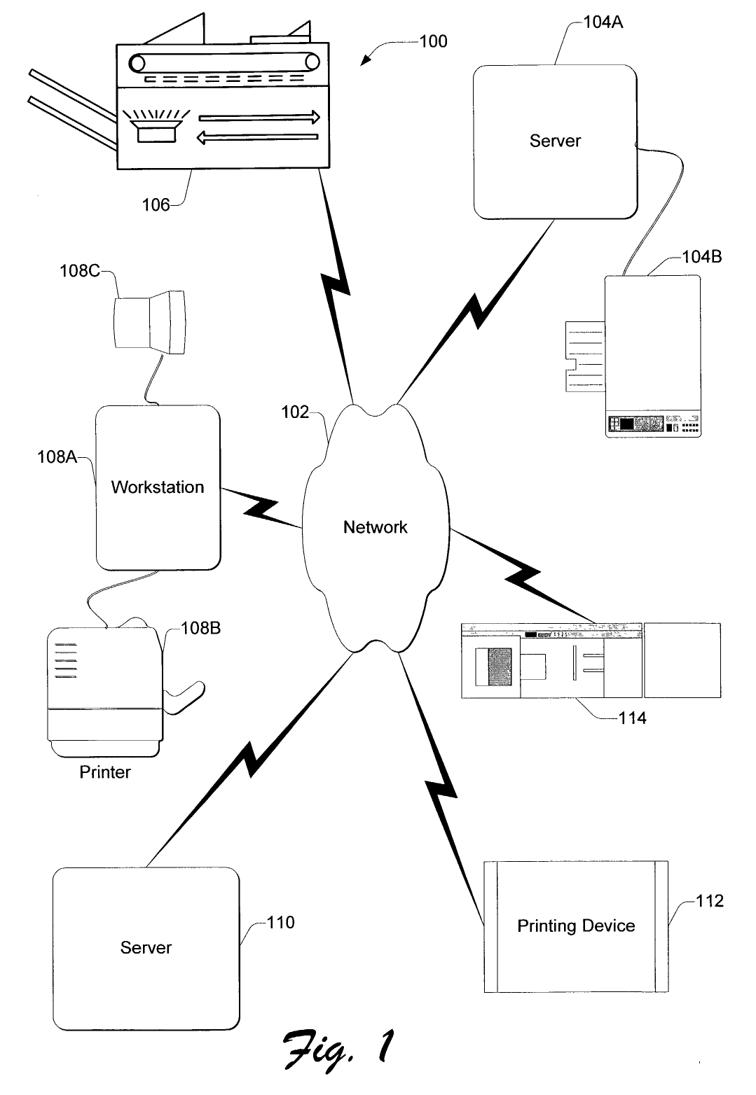

FIG. 1 illustrates a network environment 100 in which a plurality of network resources are communication via an interconnected network 102. As such, multiple servers 104A, 110, a workstation 108A, and printing devices 104B, 106, 108B, 112, 114 are coupled to one another via interconnected network 102. Interconnected network 102 couples together servers 104A and 110, computer workstation 108A, printing devices 104B, 106, 108B, 112, and 114, and a computer monitor 108C. Printing devices 104B, 108B and computer monitor 108C are coupled to interconnected network 102 through their respective local connections to server 104A and workstation 108A. Interconnected network 102 can be any type of network, such as a local area network (LAN) or a wide area network (WAN), using any type of network topology and any network communication protocol. In a particular embodiment, interconnected network 102 can be the Internet. Although only a few devices are shown coupled to interconnected network 102, a typical network may include tens or hundreds of devices coupled to one another. Furthermore, interconnected network 102 may be coupled to one or more other networks, thereby providing coupling between numerous devices. A user can schedule a print job at any server 104A, 110 or workstation 108A to be printed at any printing device 104B, 106, 108B, 112, 114.

Servers 104A and 110 may be file servers, e-mail servers, database servers, print servers, or any other type of network server. Workstation 108A can be any type of computing device, such as a mobile computing device, including a personal computer, a laptop computer, and a personal digital assistant (PDA). Although not shown in FIG. 1, one or more workstations and/or servers may contain a print rendering engine capable of converting raw print job data into a particular format (e.g., language) understood by certain types of printers.

Particular implementations illustrate an ink jet printer 104B and laser printers 106, 108B. Alternate implementations, however, are implemented with other printers such as with printing device 112 that is illustrated as being in communication with interconnected network 102 independent of a server or workstation. Printing device 112 is intended to represent a printer to which output can be directed from a computing device, including but not limited to, laser printers, ink-jet printers, bubble-jet printers, copiers, and fax machines. Additionally, printing device 112 can be any type of device that can output a print job by hardcopy such as on paper, and any other type of printer including those referred to above. A digital press or network copier 114 is seen in FIG. 1 as a printing device to which output can be direct according to an implementation.

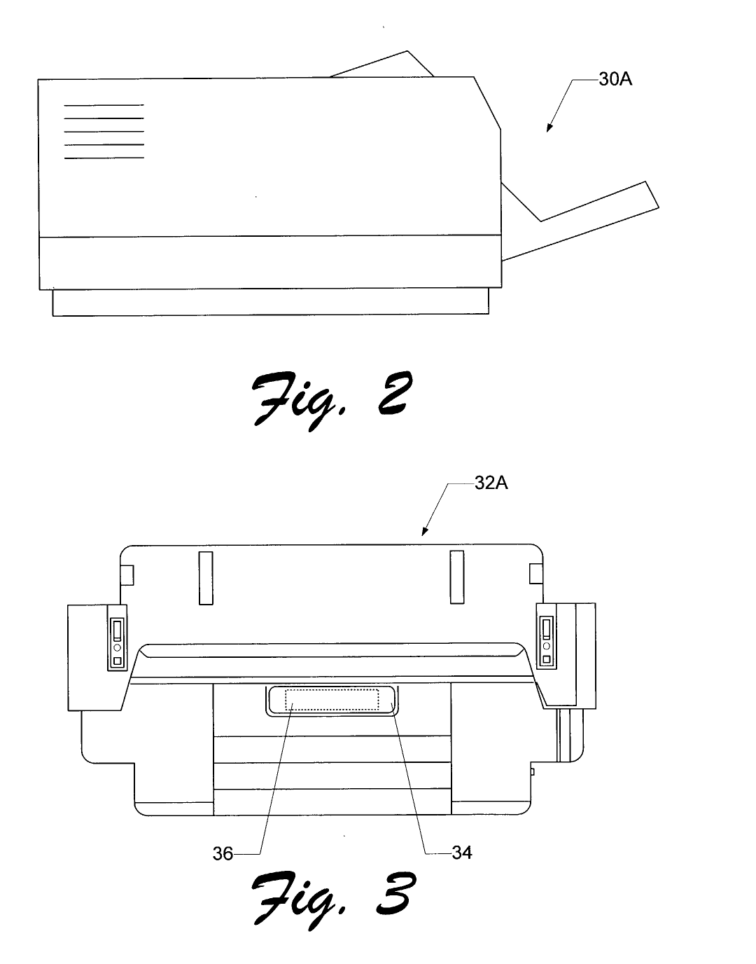

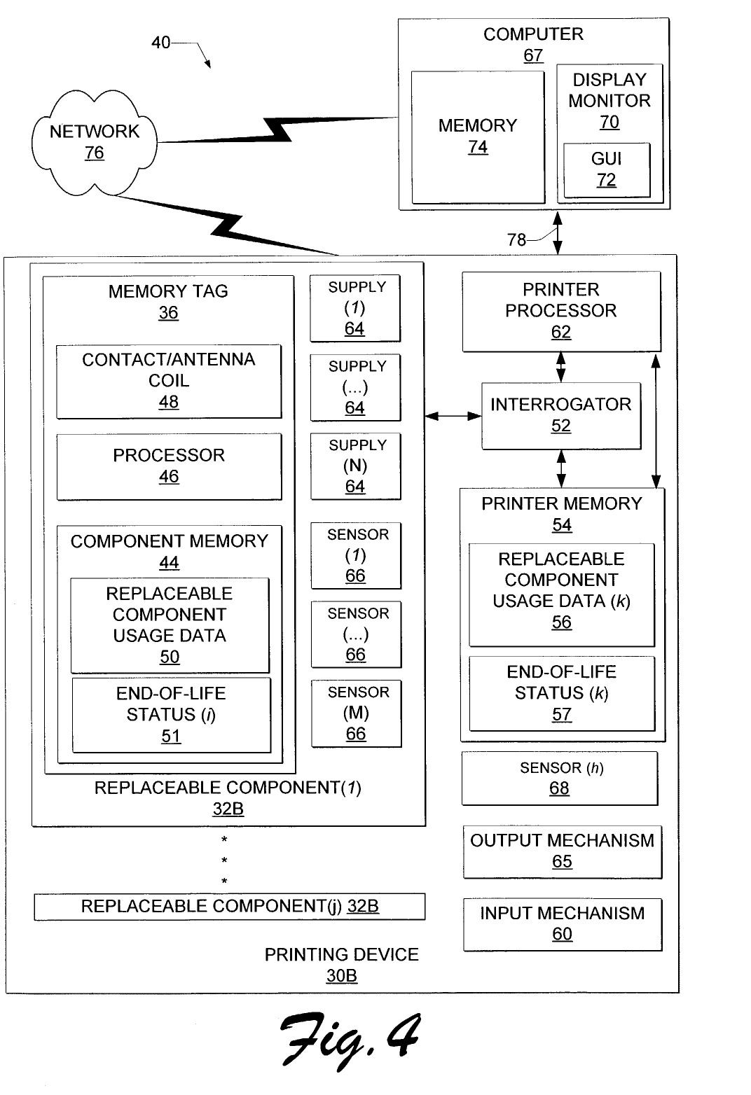

FIG. 2 is a diagrammatic illustration of a laser printer 30A in one an example of an implementation. FIG. 3 shows a toner cartridge 32A that is installable in the laser printer 30A. The toner cartridge 32A has a label 34 that contains information identifying the toner cartridge 32A to a user. The label 34 typically recites the name of the manufacturer, the model number of the cartridge, etc. Although various implementations are shown and described herein with respect to a printer toner cartridge for a laser printer, it is noted that implementations may be embodied as any replaceable component (toner cartridge, ink cartridge, fuser, drum, etc.) installable in a printing device (printer, copier, fax machine, etc.).

A memory tag 36 can be located underneath the human-readable label 34 on the toner cartridge 32A, although the memory tag 36 may be placed on the toner cartridge 32A at any location which may be practical for the purposes described herein. The memory tag 36, which can be a conventional semiconductor memory, can communicate with laser printer 30A by a direct electrical connection thereto, and would be, as such, a direct connection memory tag. Alternatively, memory tag 36 can be an RFID memory tag. RFID memory tags and applications therefore are well known in the art.

FIG. 4 is a block diagram of printing system 40 that includes a printing device 30B. Printing device 30B has replaceable component (1) 32B through replaceable component (j) 32B. Each replaceable component 32B is installed in printing device 30B and may be removed and replaced by a like replaceable component (not shown). Each replaceable component 32B can include a memory tag 36 and at least one supply 64. As seen in FIG. 4, each replaceable component 32B can have supply (1) 64 through supply (N) 64. When printing device 30B prints, the at least one supply 64 is used. Use of the at least one supply 64 by printing device 30B in printing a print job can result in the exhaustion of the at least one supply 64. At least one sensor 66 can be used to sense the quality and/or quality of the at least one supply 64. As seen in FIG. 4, sensor (1) 66 through sensor (M) 66 can be used to sense the quality and/or quality of supply (1) 64 through supply (N) 64. The number of sensors 66 need not be equal to the number of supplies 64. By way of example, and not by way of limitation, each supply 64 can be a printing supply, a printing media available to be printed on during the printing, a printing substance available for application to the printing media during the printing, toner available for application to the printing media during the printing, a laser printer drum, laser printer developer, a laser printer fuser, a printing media transfer belt, staples for stapling the printing media during the printing, a storage volume that is available to store paper that has been printed on by the printing device, etc.

Memory tag 36 has a component memory 44, a processor 46, and an electrical contact or antenna coil 48. The component memory 44 has at least one storage area that can include a replaceable component usage data 50 and an end-of-life status (i) 51. End-of-life status (i) 51 can be used to respectively store an estimated state of the end-of-life for the at least one supply 64. Memory tag 36 operates in conjunction with an interrogating device, also known as an interrogator. An interrogator is a device that provides power to, reads from and/or writes to, the memory tag 36. Examples of interrogators include a memory tag reader or scanner, a memory tag writing device which stores data on the memory tag 36, and the like. In the present example, the printing device 30B includes an interrogator 52.

The interrogator 52 can be electrically connected to contact 48 or the interrogator 52 can emits a radio frequency field that provides power to the memory tag 36 via the antenna coil 48. The memory tag 36, therefore, does not require its own power supply. Communications between the interrogator 52 via antenna coil 48 and the memory tag 36 are transmitted and received via the radio frequency field and the antenna coil 48 utilizing standard RFID method and protocol, such as promulgated in ISO 14443 and ISO 15693. Therefore, physical contact between the memory tag 36 and the printer 30 is not required for the printer 30 to communicate with the memory tag 36 as an RFID memory.

Each replaceable component 32B communicates with printing device 30B, which includes a printer memory 54. The printer memory 54 contains one or more storage areas that can include, but are not limited to, replaceable component usage data (k) 56 and end-of-life status (k) 57. Replaceable component usage data (k) 56 and end-of-life status (k) 57 store data that respectively correspond to replaceable component (1) 32B through replaceable component (j) 32B.

The printing device 30B has an input mechanism 60 that can be a toggle switch or a button that can be depressed or otherwise activated by a user. A printer processor 62 is included in printing device 30B to execute instructions for a printing operation. An output mechanism 65 can be a printing mechanism to print a print substance on print media (e.g. selectively placing printing ink on paper). Output mechanism 65 can also include a display device for displaying a diagnostic and/or a prompt.

One or more sensors 66/68 can be used to sense the quantity and/or quality of the at least one supply 64 of one or more of respective replaceable component (1) 32B through replaceable component 0) 32B. As such, each sensor 66/68 can be configured to detect the occurrence of an end-of-life condition, for example, a low toner condition in a toner cartridge, a low number of pages remaining in a page supply for printing device 30B, a predetermined number of pages that have been printed after a particular replaceable component 32B was installed in printing device 30B, a predetermined passage of time after a particular replaceable component 32B was installed in printing device 30B, etc. A non-sensor life calculation can also be made for a fuser, a transfer belt, etc.

Printing device 30B is connected to a computer 67, which can be any of servers 104A, 110 or workstation 108A seen in FIG. 1. Computer 67 includes a memory 74 and a display monitor 70. Display monitor 70 is an example of monitor 108C seen in FIG. 1. A graphical user interface (GUI) 72 is displayed on the display monitor 70 to provide visual information to the user. A user can use computer 67 to schedule a print out on printing device 30B. A diagnostic or prompt with respect to an end-of-life condition of any replaceable component 32B can be displayed upon display monitor 70. The diagnostic can be a characterization of the end-of-life condition. The prompt can be instructions to a user on how to input a demand to printing device 30B to continue printing the remainder of the print job. The prompt can also be instructions to a user to enter a number of pages of the remainder of the current print job that the user wishes to have printed. Further, the prompt can allow the user to respond with a request to print until the end of the current print job, to print a predetermined number of pages, or to print for a predetermined or user-specified period of time (e.g. 2 minutes), etc.

The computer 67 and printing device 30B are connected via a network 76, such as the Internet, a local area network (LAN), a wide area network (WAN), or the like. Alternatively, computer 67 and printing device 30B can also be connected via a direct connection 78, such as by a parallel, serial, or USB port or other conventional connection scheme.

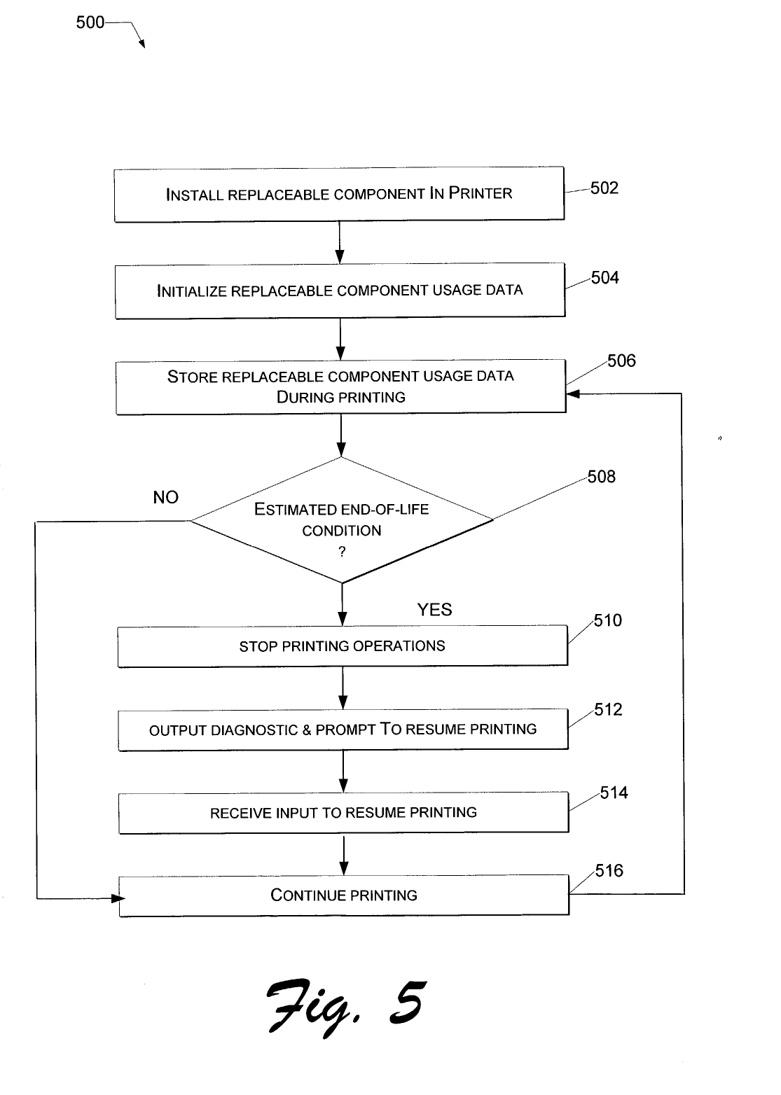

FIG. 5 depicts a process 500 in a flow diagram of a dynamic messaging process for communicating with a user, with particular reference to FIG. 4 for illustrative purposes. At block 502, a user installs a replaceable component in a printer. At block 504 the printer initializes replaceable component usage data with respect to the replaceable component. The replaceable component usage data that is initialized can be replaceable component usage data 50 in memory tag 36 of replaceable component 32B and/or replaceable component usage data 56 in printing device 30B.

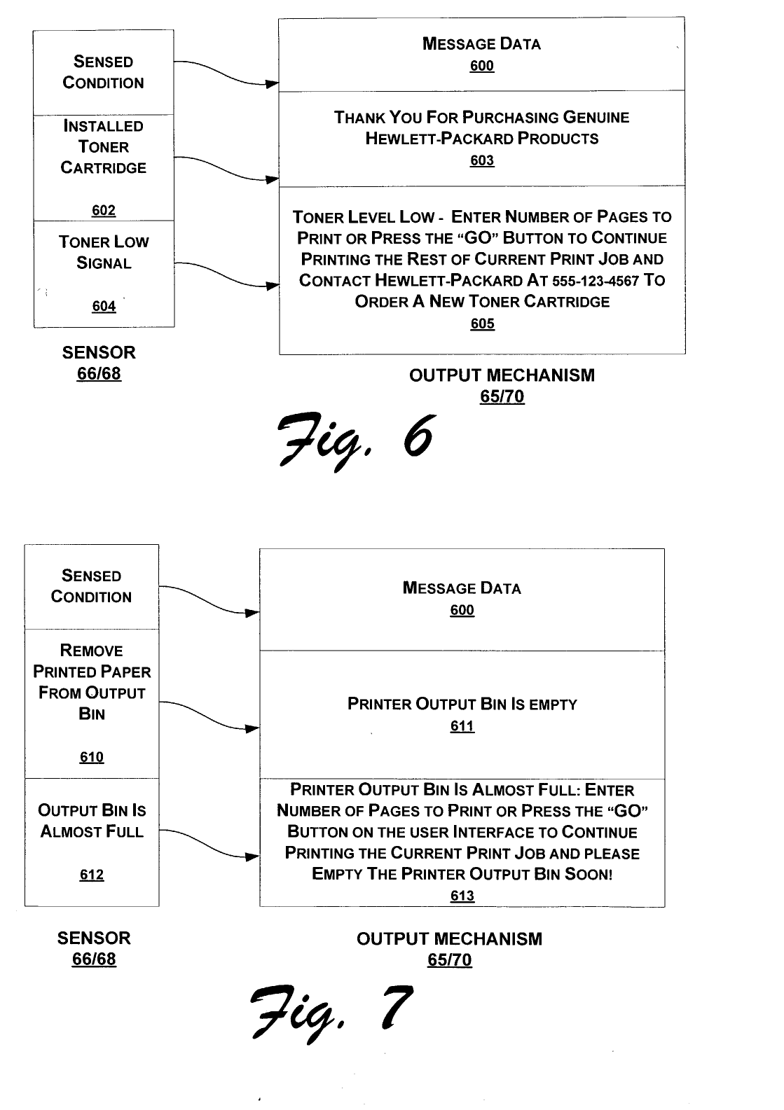

At block 506, usage data is accumulated during printing operations of printing device 30B and the usage data is stored in memory associated with the replaceable component. At block 508, an estimate is taken of the at least one supply 64 in each replaceable component 32B in printing device 30B to determine if any of the at least one supply 64 is at an end-of-life condition. The one or more estimates can be made using one or more sensors 66/68. If no end-of-life condition has been estimated, process 500 proceeds to block 516 to continue printing. Otherwise, process 500 moves to block 510 where the printing process is stopped. At block 512, the user is informed by a diagnostic as to the specifics of the estimated end-of-life condition of the particular at least one supply 64 of the particular one or more replaceable components 32B in printing device 30B. A prompt can also be output to instruct the user on how to give input to printing device 30B so that a particular number of the remaining pages in the current print job can be printed, or so that all of the remaining pages in the current print job can be printed. Example diagnostics and prompts are discussed below in reference to FIGS. 6-7.

At block 514, process 500 receives input to resume the printing of the current print job. At block 516, the printing of the current print job continues and process 500 returns to block 506 for a repetition of the indicated portion of process 500 which is described above.

The order in which a method is described with respect to process 500 is not intended to be construed as a limitation, and any number of the described method blocks can be combined in any order to implement the method. Furthermore, the method can be implemented in any suitable hardware, software, firmware, or combination thereof.

When process 500 is operated in an environment where the document processing device is a PC in communication with a printer, several parameters of operation can be implemented within the context of the rendering of the document in the PC and the rendering of the document in the printer. To process an entire print job, the printer may need the ability to interpret a language or format in which the document is stored. For example, if the document data is stored in a raw data format and the printer only understands the Printer Control Language (PCL) language, then the printer cannot process the document until some other device or process converts the raw data into a PCL format. Here, the PC can be this device or perform this process. However, if the document is already stored in a format that is understood by the printer, then the printer can process the document without assistance from an external device. If the printer can process the entire print job, then the document is printed by the printer. If the printer cannot process the entire print job, then the portions of the document (i.e., print job) that it cannot process are delegated to other processing devices.

By way of example of the foregoing process 500, particular reference is made to FIGS. 6 and 7. A sensor 66 or sensor 68 (hereinafter, sensor 66/68) can monitor toner cartridge 32A for an occurrence of relevant trigger events. For discussion purposes, a first trigger event can be when toner cartridge 32A is initially installed in the printer 30A, as seen in FIGS. 2-3.

The printer cartridge 32A is continuously monitored by the sensor 66/68 for an occurrence of the first trigger event, the installation of the toner cartridge 32A seen at reference numeral 602 in FIG. 6. When the toner cartridge 32A installation is detected, the sensor 66/68 is configured to retrieve a first user message 603 that corresponds to the first trigger event. The message data 600 can be stored in a message lookup table (not shown) contained in the memory 74, memory tag 36, and/or in printer memory 54.

Once sensor 66/68 has retrieved the first user message 603 in response to the first trigger event 602, the first user message 603 is displayed to the user on output mechanism 65. Alternatively, the first user message 603 may be passed to the computer 67 for display on the graphical user interface 72 of the display monitor 70. Any of output devices 70 or 65 can be of sufficient size to contain a complete electronic representation as shown for the user messages of message data 600, or the display may only be large enough to show one or more lines at a time.

Sensor 66/68 continues to monitor the toner cartridge 32A for an occurrence of a second trigger event 604, the activation of a toner low signal. When the toner low signal is detected, the sensor 66/68 is configured to retrieve a second user message 605 that corresponds to the second trigger event 604. Once the sensor 66/68 has retrieved the second user message 605 in response to the second trigger event 604, the second user message 605 can be displayed to the user on the output mechanism 65 of the printer 30A. Alternatively, the second user message 605 may be passed to the computer 67 for display on the graphical user interface 72 of the display monitor 70.

FIG. 7 features sensed conditions 610, 612 for which sensor 66/68 retrieves message data 600 for the output of respective user messages 611, 613 similar to the operations discussed with respect to FIG. 6. Different ways exist for sensor 66/68 to retrieve and coordinate the display of the user messages 603, 605, 611, and 613 from message data 600 stored in memory 74, memory tag 36, or in printer memory 54, such as by the execution of instructions on one or more of processor 46, printer processor 62, and/or computer 66. Those of ordinary skill in the relevant arts can use this patent as a guide in implementation of any such way.

The printed document that is printed by a printing device in various implementations can have many forms. For instance, the document can be a letter containing text that is being edited by a word processing program, an electronic mail (e-mail) message that is being created by an e-mail program, a drawing that is created by the user by operating a drawing program, a spreadsheet that the user is constructing by operating a spreadsheet program, or a poster that is being designed by a user by operating a desktop publishing program. Other types of documents are also contemplated for use in various implementations.

In various implementations, the printing device can be a simple dot matrix printer or a complex printer such as a digital press or a network printer. Complex printers can have capabilities that include high quality photo reproduction, multi-section reports with tabs, in-line mixed material insertion such as insertion of full-color preprinted copies and digital color-page insertion. Other complex printer capabilities include printing on substrates of varied composition, such as embossed, heavy-weight, multi-weight, and cover paper stock, as well as carbonless paper, blue prints, clear or colored transparency printing, and other specialty stock including preprinted offset color covers. Still other complex printer capabilities includes binding, collating, folding, stacking, stapling, stitching such as saddle stitching, edge-trimming, paginating for multi-language, and inline pagination and annotation. Still another printer is a multifunction peripheral (MFP), sometimes referred to as an “All-In-One”, which combines two or more peripheral devices into a single device, such as printing, scanning, copying, and facsimile transmission. The printer can be a Graphical Display Interface (GDI) printer or a printer interpreting a page description language.

In other implementations, the document processing application executes on the processor of the document processing device to form a bitmap image of a document that is communicated to the printing device through the interconnected network. In still another implementation, the document processing application is included in a word processing application. In yet another implementation, the document processing application includes a spooler for spooling print jobs that are to be communicated to the printing device through the interconnected network or through a hardware port on a PC.

Thus, although some implementations of the various methods, printing devices, and toner cartridges of the present invention have been illustrated in the accompanying Drawings and described in the foregoing Detailed Description, it will be understood that the invention is not limited to the exemplary implementations disclosed, but is capable of numerous rearrangements, modifications and substitutions without departing from the scope of the invention as set forth and defined by the following claims.

What is claimed is:

1. In a printing device having a replaceable component used to print, a method comprising:
stopping printing in response to an end-of-life condition of the replaceable component that signifies a potential quality degradation of the printing if the printing is resumed;
outputting a diagnostic reflecting the end-of-life condition; and
resuming the printing in response an input of a demand for resumption of the printing.

2. The method as defined in claim 1, wherein:
the printing device includes a memory for storing replaceable component usage data used in estimating the end-of-life condition of the replaceable component;
the replaceable component usage data in the memory is updated during the printing and the memory is selected from the group consisting of:
a memory integral with the replaceable component;
a memory that is not integral with the replaceable component;
a radio frequency identification (RFID) memory; and
a direct contact identification memory.

3. The method as defined in claim 1, wherein the outputting a diagnostic further comprises outputting a prompt soliciting resumption of the printing, wherein the input is in response to the prompt.

4. The method as defined in claim 1, wherein the potential quality degradation of the printing is selected from the group consisting of:
insufficiency of printing supplies in the replaceable component;
insufficiency of printing media available to be printed on during the printing;
insufficiency of printing substance available for application to the printing media during the printing;
insufficiency of toner available for application to the printing media during the printing;
insufficiency of a laser printer drum;
insufficiency of laser printer developer;
insufficiency of a laser printer fuser;
insufficiency of a printing media transfer belt;
insufficiency of staples for stapling the printing media during the printing; and
insufficiency of output volume available for the printing media to be printed on by the printing.

5. The method as defined in claim 1, wherein:
the printing device further comprises a sensor for sensing a sensed condition of the replaceable component; and
the stopping printing in response to an end-of-life condition of the replaceable component further comprises comparing the sensed condition sensed by the sensor to a corresponding predetermined quantity to determine the occurrence of the end-of-life condition of the replaceable component.

6. The method as defined in claim 5, wherein the sensed condition is selected from the group consisting of:
the availability of printing supplies in the replaceable component;
the availability of printing media available to be printed on during the printing;
the availability of printing substance available for application to the printing media during the printing;
the availability of toner in a toner cartridge for application to the printing media during the printing;
the sufficiency of a laser printer drum for the printing;
the availability of developer for the printing;
the sufficiency of a laser printer fuser;
the sufficiency of a printing media transfer belt;
the availability of staples for stapling the printing media during the printing; and
the insufficiency of output volume available for the printing media to be printed on by the printing.

7. In a printing device having an input mechanism, an output mechanism, a memory, and a replaceable component that is utilized during printing operations of the printing device, a method comprising:
storing replaceable component usage data in the memory during the printing operations after the replaceable component is installed in the printing device;
estimating from the replaceable component usage data in the memory when the replaceable component is at an end-of-life condition; and
after the estimating of the end-of-life condition:
stopping the printing operations;
outputting a diagnostic to the output mechanism reflecting the end-of-life condition of the replaceable component and a prompt soliciting resumption of the printing operations;
receiving input at the input mechanism for the resumption of the printing operations; and
resuming the printing operations in response to the input at the input mechanism.

8. The method recited in claim 7, wherein:
the output device comprises a visual display screen;
the input device comprises a toggle device on the printing device that can be toggled in response to the prompt to indicate the resumption of the printing operations.

9. The method recited in claim 7, wherein the memory is selected from the group consisting of:
a memory integral with the replaceable component;
a memory that is not integral with the replaceable component;
an RFID memory; and
a direct contact identification memory.

10. The method recited in claim 7, wherein the replaceable component is selected from the group consisting of:
printing media available to be printed on during the printing operations;
printing substance available for application to printing media during the printing operations;
toner in a toner cartridge available for application to paper during the printing operations;
a laser printer drum;
developer for a laser printer;
a fuser for a laser printer;
a transfer belt for a laser printer;
a roller for a laser printer;
staples for stapling papers together during the printing operations; and
available storage for the printing media that has been printed on by the printing.

11. The method recited in claim 7, wherein the replaceable component usage data is stored in the memory periodically during the printing operations at predetermined intervals.

12. The method recited in claim 7, wherein the estimating from the replaceable component usage data in the memory when the replaceable component is at an end-of-life condition further comprises:
comparing the replaceable component usage data in the memory to a corresponding predetermined quantity to determine the occurrence of the end-of-life condition of the replaceable component.

13. A printer comprising:
means used for printing that is exhaustible by the printing;
means for estimating the exhaustion of the means used for printing;
means for stopping printing in response to an estimate by the means for estimating that the means used for printing is exhausted;
means for outputting a diagnostic reflecting the estimated exhaustion; and
means for receiving, in response to the diagnostic, a demand for resumption of the printing.

14. The printer as defined in claim 13, wherein:
the means for outputting a diagnostic further comprises means for outputting a prompt soliciting resumption of the printing; and
the means for receiving further comprises means for receiving input, in response to the prompt, of the demand for the resumption of the printing.

15. The printer as defined in claim 13, wherein the means used for printing that is exhaustible by the printing is printing supplies and the estimated exhaustion is insufficiency of printing supplies.

16. The printer as defined in claim 13, wherein the means used for printing that is exhaustible by the printing is printing media and the estimated exhaustion is insufficiency of the printing media available to be printed on during the printing.

17. The printer as defined in claim 13, wherein the means used for printing that is exhaustible by the printing is printing substance and the estimated exhaustion is insufficiency of the printing substance available for application to the printing media during the printing;

18. The printer as defined in claim 13, wherein the means used for printing that is exhaustible by the printing is toner and the estimated exhaustion is insufficiency toner available for application to the printing media during the printing.

19. The printer as defined in claim 13, wherein the means used for printing that is exhaustible by the printing is a laser printer drum and the estimated exhaustion is insufficiency of the laser printer drum.

20. The printer as defined in claim 13, wherein the means used for printing that is exhaustible by the printing is laser printer developer and the estimated exhaustion is insufficiency of laser printer developer.

21. The printer as defined in claim 13, wherein the means used for printing that is exhaustible by the printing is a laser printer fuser and the estimated exhaustion is insufficiency of the laser printer fuser.

22. The printer as defined in claim 13, wherein the means used for printing that is exhaustible by the printing is a printing media transfer belt and the estimated exhaustion is insufficiency of the printing media transfer belt.

23. The printer as defined in claim 13, wherein the means used for printing that is exhaustible by the printing is staples for stapling the printing media during the printing and the estimated exhaustion is insufficiency of available staples for stapling the printing media during the printing.

24. The printer as defined in claim 13, wherein the means used for printing that is exhaustible by the printing is available storage for the printing media that has been printed on by the printing and the estimated exhaustion is unavailability of the available storage for the printing media that has been printed on by the printing.

25. The printer as defined in claim 13, wherein:
the means for estimating the exhaustion of the means used for printing further comprises sensing means for sensing a sensed condition of the means used for printing; and
the means for stopping printing in response to an estimate by the means for estimating that the means used for printing is exhausted further comprises means for comparing the sensed condition sensed by the sensing means to a corresponding predetermined quantity to arrive at a comparison quantity that is used by the means for estimating.

26. The printer as defined in claim 25, wherein the sensed condition is selected from the group consisting of:
the availability of printing supplies in the means used for printing;
the availability of printing media available to be printed on during the printing;
the availability of printing substance available for application to the printing media during the printing;
the availability of toner for application to the printing media during the printing;
the sufficiency of a laser printer drum for the printing;
the availability of developer for the printing;
the sufficiency of a laser printer fuser;
the sufficiency of a printing media transfer belt;
the availability of staples for stapling the printing media during the printing; and
the unavailability of storage for the printing media that has been printed on by the printing.

27. A printer comprising:
at least one replaceable component installable therein and removable therefrom, the replaceable component having component memory integrated therein;
a storing device configured to store replaceable component usage data in the component memory;
a reader/writer configured to poll the replaceable component usage data and determine an end-of-life condition for the at least one replaceable component when the polled replaceable component usage data is out of variance with at least one predetermined standard corresponding to the at least one replaceable component;
means for stopping printing upon the determination of the end-of-life condition;
means for outputting a diagnostic reflecting the end-of-life condition; and
means for resuming the printing in response to input for the resumption of the printing operations.

28. The printer recited in claim 27, wherein:
the replaceable component usage data is selected from the group consisting of:
a number of pages available to be printed in a print job;
a page counter configured to count the number of pages printed in a print job;
a quantifier of toner available for application to the pages in a print job;
a quantifier of a laser printer drum available for use in printing the pages in a print job;
a quantifier of laser printer developer available for use in printing the pages in a print job;
a quantifier of a laser printer fuser available for use in printing the pages in a print job;
a quantifier of a printing media transfer belt available for use in printing the pages in a print job;
a quantifier of staples available for stapling the pages in a print job;
a quantifier of storage available for the pages to be printed in a print job;
the reader/writer further comprises:
a sensor configured to measure the replaceable component usage data; and
means for determining from the measured replaceable component usage data that the variance with the at least one predetermined standard corresponding to the at least one replaceable component has been exceeded.

29. The printer recited in claim 27, wherein the component memory is selected from the group consisting of:
a memory integral with the at least one replaceable component;
a memory that is not integral with the at least one replaceable component;
an RFID memory; and
a direct contact identification memory.

30. A printing device comprising:
an input mechanism;
an output mechanism;
a printing mechanism;
a plurality of replaceable components used by the printing mechanism to print;
a sensor for each said replaceable component to sense an available quantity thereof;
means, in communication with each said sensor, for estimating from the available quantity a state of exhaustion of the corresponding replaceable component;
means for stopping printing with the printing mechanism in response to one said estimated state of exhaustion;
means for outputting a diagnostic to the output mechanism reflecting the one said estimated state of exhaustion; and
means for resuming the printing with the printing mechanism in response to input at the input mechanism signifying a demand for resumption of the printing operation.

31. A printing device comprising:
an input mechanism;
an output mechanism;
a printing mechanism;
a plurality of replaceable components each including at least one supply that is used by the printing mechanism to print;
at least one sensor, respectively corresponding to the at least one supply, to sense an available quantity of the supply; and
a processor to execute instructions to:
estimate a state of exhaustion for each said supply based upon a comparison of a predetermined quantity to the sensed available quantity of the respective supply;
stop printing with the printing mechanism in response to at least one said estimated state of exhaustion;
output a diagnostic to the output mechanism reflecting the at least one said estimated state of exhaustion; and
resume the printing with the printing mechanism in response to input at the input mechanism signifying a demand for resumption of the printing operation.

32. A toner cartridge installable in and removable from a laser printer, the toner cartridge comprising memory configured to store:
replaceable component usage data received from a reader/writer located in the laser printer; and
an out-of-toner status received from the reader/writer after the reader/writer estimates, based on the replaceable component usage data, that the toner in the toner cartridge is near exhaustion.

33. The toner cartridge recited in claim 32, further comprising a sensor to monitor the available quantity of toner in the toner cartridge, wherein the reader/writer receives the available quantity of toner in the toner cartridge from the sensor to estimate that the toner in the toner cartridge is near exhaustion.

34. The toner cartridge recited in claim 32, wherein the replaceable component usage data is a page count received from a page counter in the reader/writer that maintains a page count that is the number of pages printed using the toner cartridge.

35. The toner cartridge recited in claim 32, wherein the memory is selected from the group consisting of:
an RFID memory; and
a direct contact identification memory.
